(19) United States
(12) Patent Application Publication
(10) Pub. No.: US 2012/0280814 A1
(43) Pub. Date: Nov. 8, 2012

(54) SENSING AND DERIVED INFORMATION CONVEYANCE

(75) Inventors: Arthur G. Beale, Meridian, ID (US); Kevin C. Hess, Boise, ID (US); Amy E. Childress, Garden City, ID (US); Thomas P. Jensen, Redwood City, CA (US); Casimir E. Lawler, JR., Boise, ID (US); Elias H. Roby, III, Meridian, ID (US)

(73) Assignee: PAKSENSE, INC., Boise, ID (US)

(21) Appl. No.: 13/464,570

(22) Filed: May 4, 2012

Related U.S. Application Data
(60) Provisional application No. 61/482,565, filed on May 4, 2011.

(51) Int. Cl. G06F 15/00; G08B 21/00; G01L 1/00; G01P 15/00; G01K 13/00

(52) U.S. Cl. 340/540; 702/189; 702/141; 702/130; 702/41; 702/150; 702/30; 702/19; 702/24

(57) ABSTRACT

Devices, systems, and methods for sensing and derived information conveyance as disclosed. One electrical device includes an electronic circuit and executable instructions provided by at least one of: software stored in memory associated with the circuit or provided in firmware within the circuit, wherein the circuit receives raw sensor data from one or more sensors associated with the circuit, analyzes the data, and creates a report document that includes one or more features of the analysis of the data.

### BACKGROUND

Portable Document Format (PDF) is an open standard for document exchange. This file format, created by Adobe Systems in 1993, can be used for representing documents in a manner independent of application software, hardware, and operating systems. Each PDF file encapsulates a complete description of a fixed-layout flat document, including the text, fonts, graphics, and other information needed to display the document. This format can be useful in providing documents in many fields of technology.

For example, producers, distributors, warehousers, and quality personnel, among others, especially those in charge of perishable, spoilable, or high-value items that are moving through a logistics supply chain, typically have to know the condition of items for which their operation is accountable. Also, the customer perception of quality may be of value in some industries.

Further, some entities may be interested in lowering insurance premium costs. Monitoring the environment of products through use of portable sensing devices that are positioned proximate to the products as they travel is a way of gaining efficiencies, increasing traceability, and/or of providing for the quality and safety of products which can influence one or more of the above factors, among others.

In such an industry, raw data from the portable sensing devices is removed via a wired or wireless link to a computing device, such as a laptop, desktop, smartphone, or sensing device reader. This data can then be analyzed and formatted to produce any number of reports that can be useful regarding the condition of the products based upon the monitoring for the environment during storage or shipment.

### BRIEF DESCRIPTION OF THE DRAWINGS

FIG. 1 is a schematic block diagram of a circuit according to one or more embodiments of the present disclosure.

FIG. 2 is a top view of a labeled circuit assembly according to one or more embodiments of the present disclosure, providing detail of graphical features.

FIG. 3 is a perspective view depicting a pouched monitoring device incorporated into packaging according to one or more embodiments of the present disclosure.

FIG. 4 is an example of a formatted PDF image that can be generated according to one or more embodiments of the present disclosure.

### DETAILED DESCRIPTION

Embodiments of the present disclosure include a circuit that can create a PDF from raw data, for example from a sensor located on or associated with the circuit, and transmit the PDF from the circuit to another device, such as an external device (e.g., storage device). Such embodiments can, therefore transmit the data in a format that is readable on many devices without the need for special software to analyze the raw data and format the data to create a PDF to be resident on the device that receives the data.

For example, embodiments of the present disclosure can be utilized to provide a simple to use, low-cost, accurate, disposable, and/or re-usable device as an element of a monitoring system. Device embodiments, for example, can be a tag, label, or an assembly that is built into a package, or associated shipping item, such as a pallet.

In such embodiments, the device can comprise a circuit board (e.g., printed circuit board) containing a sensor or sensors, a power source, and/or other electronic circuitry. In various embodiments, the device can, for example, be as small as about 1.5 inches square by about 0.1 inches high, which can be fit into larger materials. Some embodiments utilize a clear pouch that forms an outer layer over the circuit assembly. Various embodiments may utilize a plastic or metal shell or may have no enclosure at all.

Methods of manufacturing and using such monitoring devices are described. Further, the present disclosure provides method embodiments for communicating with such devices and conveying their data in ways that fit the applications that they are intended to address. The features, functions, and/or advantages of the present disclosure can be achieved independently in various embodiments of the present disclosure, or may be combined in yet other embodiments.

The present disclosure describes a number of device, system, and method embodiments. For example, in some device embodiments, the device includes an electronic circuit and associated executable instructions (e.g., software, firmware, etc.), enclosed in a label, tag, or package, that monitors environmental conditions.

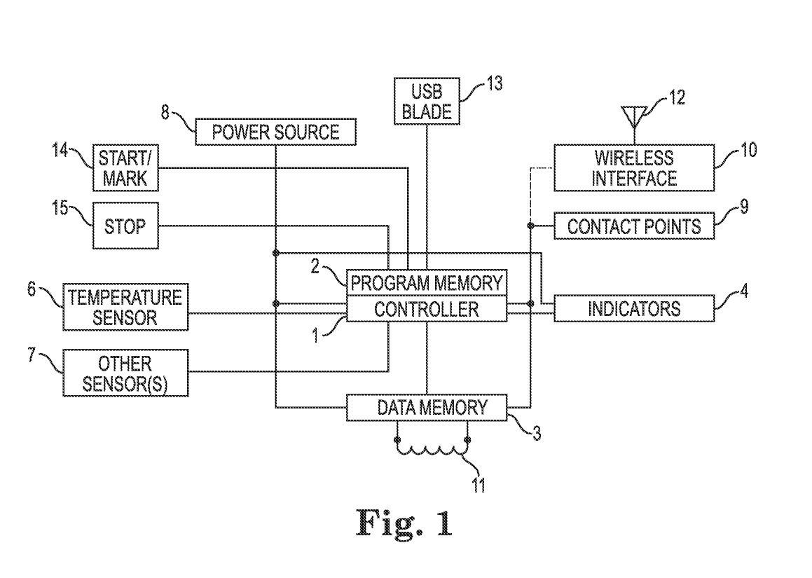

FIG. 1 is a schematic block diagram of a circuit according to one or more embodiments of the present disclosure. For example, the embodiment of FIG. 1 provides an electrical device having an electronic circuit and executable instructions provided by at least one of software stored in memory associated with the circuit or provided in firmware within the circuit, wherein the circuit receives raw sensor data from one or more sensors associated with the circuit, analyzes the data, and creates a report document that includes one or more features of the analysis of the data.

In some such embodiments, the circuit can create the report document one or more of a Portable Document Format (PDF) document, comma separated values file (CSV), text data or information, static device information, certificate of calibration, reference table, or reference data. For instance, a circuit can create a PDF document having CSV information within the PDF or can create multiple files and in some implementations, the files can be of different formats.

Static device information can, for example, be model name, number, firmware or software version, sensing type, or other non-sensing data related information. A certificate of calibration can, for example, be a validation document that indicates that the device is currently within specification, complies with one or more standards, indicates a date or circumstance beyond which a device should not be used, or is an authorized sensing device that can be used for a particular purpose.

Additionally, the circuit creates the report document independent of external processing. In other words, the circuit includes all of the functionality necessary to create these documents and therefore, does not need additional functionality provided by an external device to create the one or more documents.

Further with regard to the form factor of the device or system, the device or system can be provided in any form. For example, the circuit can be enclosed in one of a label, tag, or package. Such a form factor may be desirable, for example, in environments wherein the device or system monitors one or more environmental conditions. Environmental conditions can include but are not limited to, for example, acceleration, ionizing radiation, electro-magnetic energy, sound, temperature, force, orientation, chemical presence, chemical change, bacterial, viruses, light, and humidity, as will be discussed in more detail below.

In some embodiments, the circuit includes a circuit board containing one or more sensors, a power source, and circuitry for receiving data from the one or more sensors, analyzing the data, and creating the report document. Such an example, is provided in FIG. 1.

In some embodiments, the circuitry for receiving data from the one or more sensors, analyzing the data, and creating the report document can create multiple different reports from the analyzed data. This may be beneficial, for example, where a user would like multiple reports having different information regarding one sensor thereon (time vs. temperature, temperature high/low, temperature average) or regarding multiple sensors (e.g., time vs. temperature, time vs. humidity, time vs. orientation, temperature average).

The created documents can be handled in a variety of manners. For example, in some embodiments, the device or system includes a machine readable medium such as memory associated either as part of the electrical circuitry or connected thereto for storing executable instructions, data (raw and/or analyzed), and/or created report documents. Memory (2, 3 of FIG. 1) can be volatile or nonvolatile memory. Memory can also be removable (e.g., portable) memory, or non-removable (e.g., internal) memory. For example, memory can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disk read-only memory (CD-ROM)), flash memory, a laser disk, a digital versatile disk (DVD) or other optical disk storage, and/or a magnetic medium such as magnetic cassettes, tapes, or disks, among other types of memory.

Further, although memory is illustrated as being integrated within the device of FIG. 1, embodiments of the present disclosure are not so limited. For example, memory can also be located internal to a computing resource (e.g., enabling machine readable instructions to be downloaded over the Internet or another wired or wireless connection).

Memory can also store executable instructions, such as, for example, computer readable instructions (e.g., software), according one or more embodiments of the present disclosure. Controller 1 can execute the executable instructions stored in memory in accordance with one or more embodiments of the present disclosure. The controller can be any circuitry that provides the functions discussed herein. One suitable example of a controller is a microcontroller.

As used herein, an external device can be any device that can be utilized to receive the data. For example, some suitable external devices include, but are not limited to, computing devices, storage devices, displays, and projectors.

In some embodiments, the device or system may not have memory for storing the created documents or it may be preferable in some applications to send the documents directly to another device. In such embodiments, the device or system can include transmitter circuitry for directly transmitting the document to an external device as the document is created.

Such circuitry can provide the transmission in a wired and/or wireless manner. For example, in some embodiments, the circuitry can include transmitter circuitry that transmits via a wired communication link, such as a Universal Serial Bus (USB) as discussed in more detail herein.

In some embodiments, the link can be a connection port for wired connection to a computing device. The wired connection port for transmitting the report document wirelessly to an external device can, for example, include one or more connectors, such as one or more blade contacts. Blade contacts can be provided, for example, by etching the contacts from a printed circuit board, such as a circuit board on which other electrical circuit components of the device or system reside. In various embodiments, a system can, for example, include a controller, electronic circuitry coupled to the controller to receive raw sensor data from one or more sensors associated with the system, and executable instructions provided by at least one of software stored in memory associated with the circuit or provided in firmware within the system, wherein the controller, analyzes the data, and creates a report document that includes one or more features of the analysis of the data.

As discussed above, in some embodiments, the device or system can include a machine readable medium having executable instructions which can be executed by a controller to cause a machine to perform a method. Instructions could for example, include receiving, with electronic circuitry, raw sensor data from one or more sensors associated with the circuit, and analyzing the data with executable instructions, provided by at least one of software stored in memory associated with the circuit or provided in firmware within the circuit, and creating a report document that includes one or more features of the analysis of the data.

In some embodiments instructions may also include generating an alert condition via one or more alert mechanisms to indicate a condition of the analyzed data. This can be accomplished, for example, by generating an alert condition includes generating the alert condition by causing one or more light emitting diodes to illuminate.

In various embodiments, the instructions can include generating a template that serves as a standardized page format, followed by textual and graphical information that summarizes and graphs the sensor data. A general template can also be created by formatting an initial document page including defining any geometric constructions and defining any verbiage to be used within the document. Geometric constructions can be any geometric form that is present in the document (e.g., boxes, circles, spaces in the document). Such verbiage can, for example, be retrieved verbiage from memory associated with the electronic circuitry based on the defined verbiage needed for formatting the initial document page, as discussed in more detail herein.

In some embodiments, a device or system can be in the form of a label, tag, or package or be incorporated into a label, tag, or package, as discussed in more detail herein. In some such embodiments, the device or system can have the ability for the label, tag, or package to convey its information to users in a variety of ways. For example, as shown in FIG. 1, a circuit of the label, tag, or package may include one or more of a controller, such as a microcontroller and/or other program control logic 1, a program memory 2 (e.g., read-only, read-writable), a data memory 3, a display and/or indicators 4, a temperature sensor 6, one or more other sensors 7, such as humidity, orientation (e.g., tilt, up/down orientation), force (e.g., shock, pressure), light, or others. Other sensors may be located remotely from the circuit assembly and connected by way of wired connection, such as by a thin cable, or wirelessly.

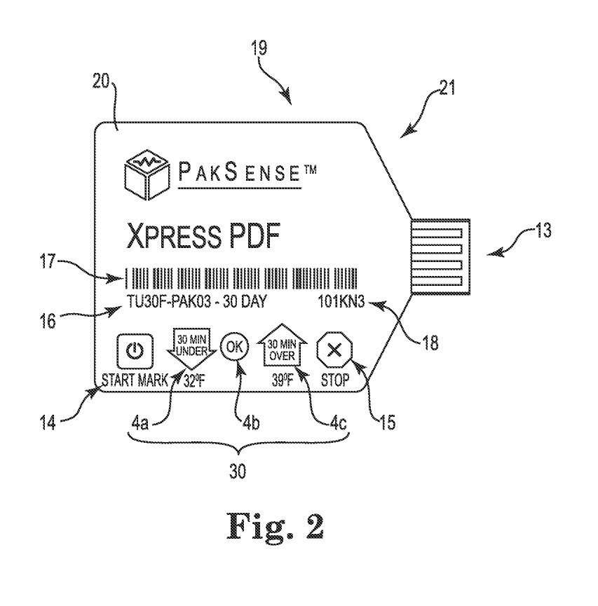

The circuit assembly of the label, tag, or package can include a Start/Mark pushbutton switch 14, a Stop switch 15, and a power source 8. The circuit assembly can also include a Universal Serial Bus (USB) connector, such as a USB Type A male connector, which can be constructed, for example, as a blade 13 built as a part of the printed circuit board. The blade contacts can be etched from the printed circuit board, as shown in FIG. 2. Alternately, the USB connector can be a separate component, such as a Kycon KUSB series plug connector, that can be surface mounted onto the printed circuit assembly. The USB connector can be plugged into a USB Type A female connector on a host PC or similar host device.

A communications mechanism, such as, for example, a set of target contact points 9, suitable for contacting with an external probe device, or a wireless interface 10, such as infrared or radio frequency modulation circuit, can be incorporated into the circuit. Antenna 12 can be integrated into the circuit assembly as a circuit board trace or as a surface mounted component, as a means of transmitting and/or receiving radio waves. Some purposes of the hardware described above, for example, can be to provide mechanisms for sensing environmental variables, performing storage of measured data, performing processing of the measured data (e.g., under embedded software control), providing display indications, of processed data and/or providing upload capability of external data.

In some embodiments, data memory 3 may have a data port that communicates the memory contents via electromagnetic connection to an external reader device. In the embodiment of FIG. 1, the inductive coupler circuit element 11 facilitates this electromagnetic interface.

In some embodiments, a flexible or rigid printed circuit assembly can serve as a substrate or mounting surface for the electronics. For example, the electronic components can be provided as surface mounted components. Some embodiments, such as is illustrated in FIG. 1, incorporate power source 8 (e.g., a tab-mounted coin-cell type power source) into the circuit assembly.

Also present in FIG. 1, are a number of indicating Light Emitting Diodes (LEDs) as indicators 4. Such indicators can, for example, be arranged to indicate an upper yellow, a center green, and a lower yellow light as indicators 4.

FIG. 2 is a top view of a labeled circuit assembly according to one or more embodiments of the present disclosure, providing detail of graphical features. In some embodiments, a label graphic can be constructed (e.g., from plastic film), as is shown in FIG. 2. A cover for example including the label graphic, can be used to cover the circuit assembly. In such embodiments, the cover can include printed features on its surface.

In some embodiments, a cover can also be made larger such that it can be folded to cover both the front and the back of the Printed Circuit Assembly (PCA). In various embodiments, an area of the cover can be printed with legend information (e.g., text and/or symbols) that identifies what the one or more indicators signify. The label can be fabricated from any suitable material including translucent or opaque materials and can be provided as a clear material with overprinting thereon, in some embodiments.

In embodiments that utilize one or more illuminating indicators, such as LEDs, the indicators can illuminate printed lenses 30, for example, from behind. The legend information associated with the indicators (e.g., adjacent to the lenses 30 in FIG. 2), can be modified to suit the measurement and/or alert parameters that are programmed. Such lenses 30 can, for example, be arranged to indicate an upper yellow, a center green, and a lower yellow light as indicators 4a, 4b, and 4c, respectively.

In operation, the LEDs can be constructed to indicate an upper yellow, a middle green, and a lower yellow light on the surface of the device, when shining through the lenses. In this configuration, the upper yellow indicator can serve as an over limit status indicator, the lower yellow indicator as an under limit status indicator, and the center green indicator can serve as an OK status indicator.

In such embodiments, the LED indicators can, for example, flash once every few seconds, and can also perform double, triple, or coded flashes to signify different status conditions, again as programmed to suit particular applications. An aspect of having indicators that are able to respond to programmatic settings and to indicate derived parameters is that they can provide a summary of events that occur over time. In effect, the one or more indicators can provide a compressed form of data to the viewer.

Various embodiments can use plastic films that accept inks that can be printed by ink-jet, laser, flexographic, and/or other suitable printing processes. Some embodiments may be capable of utilizing the high-resolution and/or deep color saturations possible using off-the-shelf printers, such as those available from Hewlett Packard, Canon, or Primera.

Embodiments can also include other graphic elements such as a logo, model or part number 16, bar code data 17, serial number 18, and/or a temperature limit graphic, as illustrated in FIG. 2. The logo and model or part number 16, as well as the temperature limit graphic can be used, for example, to provide a package, tag, or label to be supplied with a unique graphic that is matched to the parameters that are programmed into a controller's program memory 2 and/or data memory 3, as illustrated in FIG. 1.

For instance, features 17 and 18 can provide identification of the target product and its parameters. In some embodiments, a circuit assembly (e.g., printed circuit) with a cover label 20, as depicted in FIG. 2, can be inserted into a pouch 19. The pouch 19 can be of any suitable material and can be sealed permanently or resealably in any suitable manner. For instance the pouch can be heat-sealed, glued, or have a physical sealing structure formed from the pouch material. In order to access the USB blade 13, the pouch 19 can incorporate a tear-notch 21, such that the pouch 19 can be more easily opened.

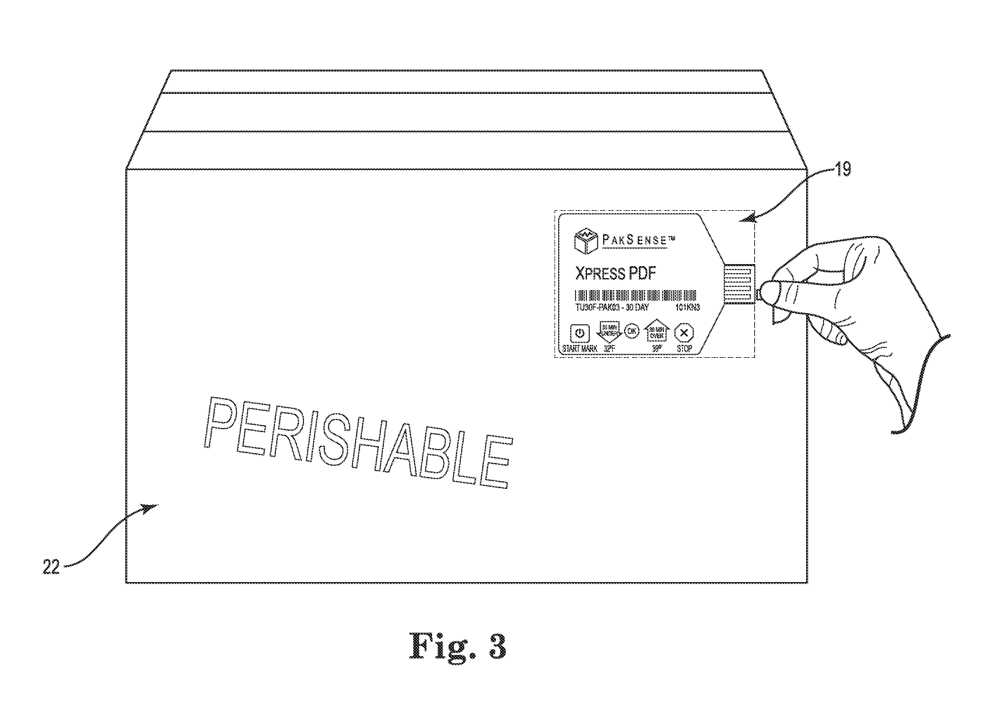

FIG. 3 is a perspective view depicting a pouched monitoring device incorporated into packaging according to one or more embodiments of the present disclosure. Embodiments can be constructed, as illustrated in FIG. 3, that incorporate the pouched assembly 19 into a package 22 can be constructed such that assembly 19 is easily removable from the package surface in order to be subsequently opened and inserted into a target PC or similar host device for reading of data.

Various label, tag, or package-based device embodiments can be provided that process and/or store data. Embodiments can facilitate communication of the data to reader devices. In such embodiments, reader devices can communicate by way of any suitable direct connection (e.g., via the use of probe pins) or any suitable wireless connection type. Suitable types of wireless connections include infrared, LEDs (e.g., in data transmission mode, can emit pulsed visible light), and/or radio frequency modulation, among many other connection types known to those in the art.

With respect to embodiments utilizing a radio frequency communication connection, radio frequency based readers can utilize a one-way (transmit only) or a two-way radio mechanism to be associated with the tag, label, or reader device. Likewise, a one-way (receive only) or two-way radio connection can be used by the reader device to match the tag, label, or package device with which it will be communicating.

These data radio mechanisms can be based upon established standards or based upon proprietary radio technologies. The radio mechanisms associated with the tag, label, or package devices may also participate in a networked (e.g., mesh network) or similar interface scheme to communicate with other tags, labels, packages, and/or reader devices. These types of networks may fall within IEEE 802.15.4 standards development, among others.

Another aspect of the present disclosure is that its internal program (firmware) operates in such a way that when it is inserted into the USB female connector of a host PC or similar host device it automatically generates a PDF image that is transmitted electronically across the USB interface for immediate display and/or printout. Using the present disclosure in this manner offers distinct advantages in that no external software need be previously or simultaneously installed or executed in a target host PC or other similar host device. This scheme eliminates the need to distribute software, such as a special drivers or custom interface programs, to users of one or more embodiments of the present disclosure. Another advantage of the present disclosure is that intermediary hardware reading devices are not required in order to obtain data from devices according to the present disclosure.

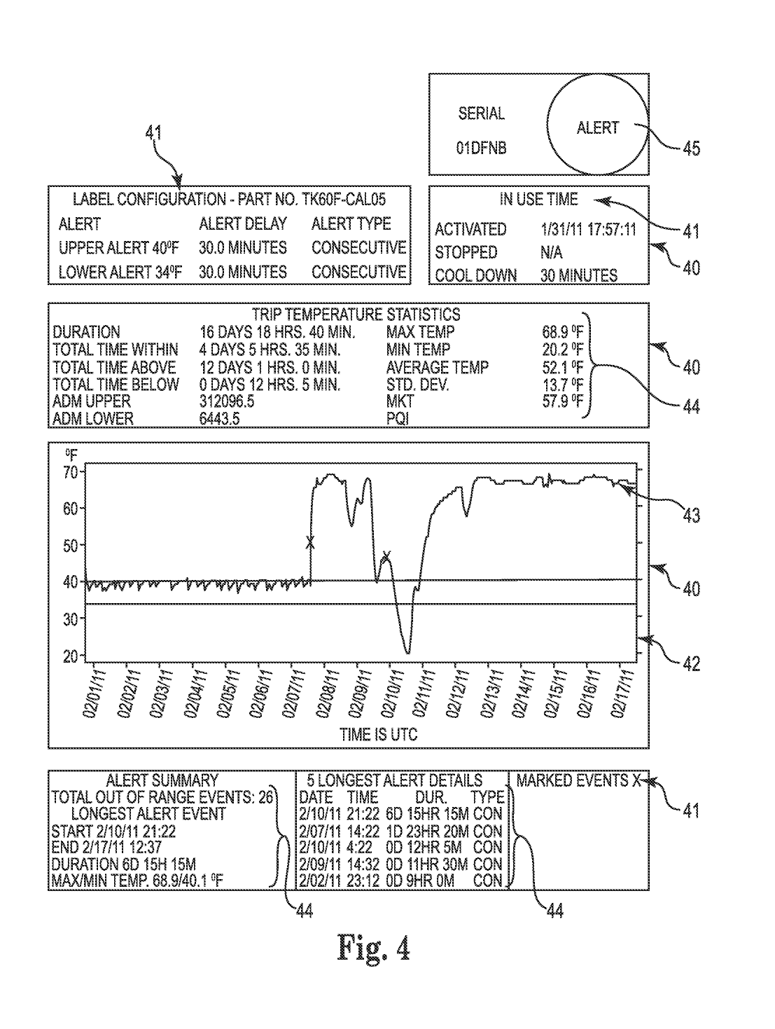

FIG. 4 is an example of a formatted PDF image that can be generated according to one or more embodiments of the present disclosure. The internal firmware or software program of the present disclosure follows the Adobe Standard PDF reference, version 1.4 or later. In order to generate a PDF file, the firmware/software of the present disclosure first generates and transmits a template that serves as a standardized page format, followed by textual and graphical information that summarizes and graphs the recorded environmental data. The initial page formatting including any boxes 40 and verbiage 41 can be executed in several ways. For example, the boxes can be created programmatically, while the standard verbiage can be read from previously stored memory, which can be stored in the controller's program memory 2 and/or in data memory 3, as illustrated in FIG. 1.

PDF data depicting the recorded history of one or more periodically sampled environmental variables 43 can be plotted in a graphical template 42. The graph can be auto-scaled in both the x-axis and the y-axis, based upon the span of time in the x-axis, and the span of the periodically sampled environmental variable can be scaled in the y-axis. Statistical summary data 44 is presented following a programmatic calculation. An OK or Alert symbol 45 based upon presence of an alert condition, which may or may not be customer specific. Label data marking can be accomplished by incorporating graphical symbols such as circles or triangles, for example, into the graph area. Marked event times and dates can also be displayed in the summary data.

In the tag, label, or package device of the present disclosure, alerts can be calculated in the program firmware/software using parametric equations, such as polynomials, such as (y=ax³+bx²+cx+d), or by using the Arhennius equation, commonly described as (y=ne^{-kt}). Alerts can also be calculated as a specified passage of time above or below threshold levels, either in consecutive increments or in cumulative amounts over differing, programmatically measured periods of time. Each of these approaches to providing alerts is accepted in specific applications across various industries, based upon differing environmental factors. Embodiments of the present disclosure may also be used without alert capabilities to record the environmental data into data memory 3 over a period of time. Such applications of the present disclosure may be referred to as data logging.

In the tag, label, or package device of the present disclosure, executable instructions can be loaded and executed by the controller or other control logic of the device. Example instructions that can be executed are outlined in the program listing attached as an appendix hereto.

The executable instructions (e.g., loaded or embedded software/firmware) can implement a method of data compression, whereby sensor readings can be compared to past readings and decisions can be made, based, for example, upon programmed, settable parameters and/or upon the value of the new data. For instance, if a new reading is within one or more settable window limits as compared to the last reading, then the new reading is not stored, and if outside of the limits, then the reading is stored.

Another storage condition can be used, such that if a settable period of time has passed since the last storage of a reading, then a new reading will also be stored. Such criteria (e.g., limits and periods of time) can be designed to be pre-programmed and/or programmable in the field, in various embodiments.

Some embodiments can employ and make use of specific parameters, previously stored in the program memory 2, or the data memory 3 contained within the tag, label or package circuit, for example, to establish the personality of a device such as a tag, label, or package, among other uses. The executable instructions, for instance, read these personality parameters upon activation, allowing for executable instructions to then behave according to loaded parameters.

In some embodiments, one of the features includes the ability to wirelessly program a personality of a device (e.g., a label), as well as wirelessly read raw data from the device.

In such embodiments, environmental alert triggers and their associated trigger timings, along with other device behavioral characteristics, can be loaded into a portion of memory on the device (e.g., outside of a base firmware program). This allows a manufacturer to program a validated code basis into a large number of devices, and then at a different time add information that creates a device product with customized features. This file, containing the later stage behavioral customization, can be referred to as a “Personality Profile” of a device.

In one embodiment, this Personality Profile is added via a wired interface. In another, a wireless interface is utilized, such as a near-field wireless interface, to program in the Personality Profile into a device. One or many can be programmed at a time.

In a similar embodiment, this same type of wireless interface may be used to read data, such as the raw temperature data as well as the Personality information, out of the device and transfer it to an external device.

A near-field wireless transmitter system, used for exchanging information with the device could include an antenna in the form of a pad, attached to a computer running software. A device or group of devices placed on that near-field pad would have their near-field circuitry energized by the electro-magnetic field of the antenna. When energized, commands and responses may be exchanged between the software via the computer and antenna, and the device itself. This antenna pad may be of a variety of sizes, and either horizontally or vertically oriented.

The parameters can be data that allow configuration set points of, for example, limits for over-temperature, under-temperature, or time-temperature integration thresholds. Other parameters, can include serial numbers, model numbers, times, locations, and/or data sample rates, among others. This information can allow for indication and alert modes to be stored, retrieved and utilized to set specific desired operations, among other functions.

Various embodiments include the incorporation of printed information onto the front and/or back surfaces of the package, tag, or label, which can, for example, be printed during manufacturing. Executable instructions, including, for example, specific compiled or assembled program code and/or parametric or personality data, as described above, can be written (e.g., via a manufacturing fixture) to the program memory 2 and/or one or more data memory 3 components of a generic PCA that is to be finalized into a tag, label, or package.

Although specific embodiments have been illustrated and described herein, those of ordinary skill in the art will appreciate that any arrangement calculated to achieve the same techniques can be substituted for the specific embodiments shown. This disclosure is intended to cover adaptations or variations of various embodiments of the disclosure. It is to be understood that the above description has been made in an illustrative fashion, and not a restrictive one.

Combination of the above embodiments, and other embodiments not specifically described herein will be apparent to those of ordinary skill in the art upon reviewing the above description. The scope of the various embodiments of the disclosure includes various other applications in which the above structures and methods are used.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

PROGRAM LISTING

```
  PROGRAM MAIN
    [Program gets here upon Power On or Reset condition]
    Call INIT routine
    Read ALERT register from external EEPROM
    Check ACTIVATED flag to see if part has already been activated
      While ACTIVATED flag is FALSE put processor to sleep
for fifteen seconds:
    Increment sleep interrupt counter and check eight-minute timer
          If >= eight minutes
          Increment activation stamp in EEPROM
      Set sleep interrupt counter to 0
    If ACTIVATED flag is TRUE
    Disable Timer1
    Disable External Interrupt
    Set ALERT register bit that corresponds to activated flag to TRUE
    Write sleep interrupt counter to ext EEPROM
    Take a temperature reading
    Multiply reading by number of readings to average
    Store result in ext EEPROM as first reading
      Strobe all LEDS to indicate that part has been activated
    Take a temperature reading
    Read needed variables from ext EEPROM
    Enable Timer1 interrupt
    MAIN LOOP
    While one minute counter has not reached one minute:
          Call go to sleep function
          Call READ_ALERT_REGISTER
          Increment one minute counter
    Increment five-minute counter
    Call ADD_FIFO
    If five minute counter has reached number of readings to average:
          Reset five minute counter to 0
          Call SUM_FIFO function
          If MEMORY_FULL flag is FALSE:
    Increment LAST_STORED_VALUE counter
    If summed temperature is above or below variation limits:
          Call SET_VARIATION_LIMITS
          Call STORE_DATA_POINT
          Reset stored value counter to 0
    Else (It has been some time since EEPROM was written)
          Call STORE_DATA_POINT function
          Reset stored value counter to 0
          If TTI flag is FALSE and BEFORE_ALERT flag is TRUE
    If summed temperature is above upper limit:
          If OT1 flag is FALSE:
    Increment OT1_ALERT counter
    If OT1_ALERT counter has exceeded some limit:
          Set ALERT register bit that corresponds to OT1_ALERT flag
          Set OT1_ALERT flag to TRUE
    Reset UTI_ALERT counter to 0
    Else, if summed temperature is below lower limit:
          If UTI_ALERT flag is FALSE:
    Increment UTI_ALERT counter
    If UTI_ALERT counter has exceeded some limit:
          Set ALERT register bit that corresponds to UTI_ALERT flag
          Set UTI_ALERT flag to TRUE
    Reset OTI_ALERT counter to 0
    Else reset OTI_ALERT and UTI_ALERT counters to 0
          If TTI flag is FALSE:
    If summed temperature < 0
          Set original temperature to 0
    Else set original temperature to summed temperature
    Do TTI calculation
    If MAX_LIFE accumulator > 1
          Set ALERT register bit that corresponds to TTI_ALERT flag
          Set TTI_ALERT flag to TRUE
    Store max life accumulator value in ext EEPROM
          If BEFORE_ALERT flag is FALSE
    Increment BEFORE_ALERT counter
    If BEFORE_ALERT counter has exceeded some limit:
          Set ALERT register bit that corresponds to BEFORE_ALERT
          flag
          Set BEFORE_ALERT flag to TRUE
          If there has been a change in ALERT register
    Call STORE_DATA_POINT function
  Function: EXTERNAL_INTERRUPT
    Wakes label from sleep and sets activation flag
  Function: SET_ALERT_REGISTER
    Call bit set method
    Write new value of alert register to ext EEPROM
  Function: STORE_DATA_POINT
    Get next storage location from ext EEPROM
    If data type parameter is 1
    Store summed temperature in ext EEPROM
    Else store ALERT register in ext EEPROM
    Increment next storage location
    If next storage location is greater then capacity
    Set ALERT register bit that corresponds to memory full flag
    Set MEMORY_FULL flag to TRUE
    Write next storage location to ext EEPROM
  Function: SET_VARIATION_LIMITS
    Get plus/minus value from ext EEPROM
    Set upper limit and lower
    Function: SUM_FIFO
    Sum values in FIFO buffer
    Set average temperature to result
  Function: ADD_FIFO
    Take a temperature reading
    Shift values in FIFO one place
    Add temperature reading to FIFO
  Function: READ_ALERT_REGISTER
    If TTI bit in alert register is TRUE (1)
    Call flash function with TTI
    Call delay function
    Call flash function with TTI
    Else if over or under alert bits are set (1) in alert register:
    Determine if one or both alerts are set
    Call flash function with over alert, under alert or both
    Call delay function
    Call flash function with over alert, under alert or both
    Else call flash function with OK
    Call delay function
    Call flash function with OK
  Function: SLEEP
    Do housekeeping for low power
    Get Timer1 value so we know how long to sleep
    Call set Timer1 with sleep length value to wake again
    Call SLEEP function
    Wake-Up point, set Timer1 to 0
  Function: FLASH
    Turn on appropriate LEDS
    Call delay function to delay for LED ON TIME
    Turn LEDS off
  Function: INIT
    Set MCU ports and mode
    Call to initialize external EEPROM
    Call to initialize temperature sensor
    Call to setup temperature sensor as a one shot read
    Enable interrupts
    Setup ports for inputs and outputs
    Strobe through LEDS calling flash function
```

That which is claimed is:

1. An electrical device for sensing and derived information conveyance, comprising:
an electronic circuit; and
executable instructions provided by at least one of: software stored in memory associated with the circuit or provided in firmware within the circuit, wherein the circuit receives raw sensor data from one or more sensors associated with the circuit, analyzes the data, and creates a report document that includes one or more features of the analysis of the data.

2. The electrical device of claim 1, wherein the circuit creates the report document as one or more of a Portable Document Format (PDF) document, comma separated values file (CSV), text data or information, static device information certificate of calibration, reference table, or reference data.

3. The electrical device of claim 1, wherein the circuit creates the report document independent of external processing.

4. The electrical device of claim 1, wherein the circuit is enclosed in one of a label, tag, or package, that monitors one or more environmental conditions.

5. The electrical device of claim 1, wherein the circuit includes one or more sensors to monitor one or more environmental conditions selected from the group including:
acceleration;
ionizing radiation;
electro-magnetic energy;
sound;
temperature;
force;
orientation;
chemical presence;
chemical change;
bacterial;
viruses;
light; and
humidity.

6. The electrical device of claim 1, wherein the circuit includes a circuit board containing one or more sensors, a power source, and circuitry for receiving data from the one or more sensors, analyzing the data, and creating the report document.

7. The electrical device of claim 6, wherein the circuitry for receiving data from the one or more sensors, analyzing the data, and creating the report document can create multiple different reports from the analyzed data.

8. The electrical device of claim 1, wherein the device includes memory for storing the created report document.

9. The electrical device of claim 1, wherein the device includes transmitter circuitry for directly transmitting the document to an external device as the document is created.

10. The electrical device of claim 1, wherein the transmitter circuitry transmits wirelessly.

11. The electrical device of claim 1, wherein the transmitter circuitry transmits via a wired communication link.

12. A system, comprising:
a controller;
electronic circuitry coupled to the controller to receive raw sensor data from one or more sensors associated with the system; and
executable instructions provided by at least one of software stored in memory associated with the circuit or provided in firmware within the system, wherein the controller, analyzes the data, and creates a report document that includes one or more features of the analysis of the data.

13. The system of claim 12, wherein the system includes a wired connection port for wired connection to an external device.

14. The system of claim 13, wherein the wired connection port for transmitting the report document to the external device includes one or more blade contacts that are etched from a printed circuit board.

15. The system of claim 13, wherein the wired connection port for transmitting the report document to the external device includes one or more connectors.

16. The system of claim 12, wherein the system includes circuitry for transmitting the report document wirelessly to an external device.

17. The system of claim 12, wherein the controller can receive instructions, wirelessly from an external device, to program a personality of the system.

18. The system of claim 12, wherein the system can wirelessly send raw data to an external device.

19. A machine readable medium having executable instructions which can be executed by a controller to cause a machine to perform a method, comprising:
receiving, with electronic circuitry, raw sensor data from one or more sensors associated with the circuit; and
analyzing the data with executable instructions, provided by at least one of software stored in memory associated with the circuit or provided in firmware within the circuit, and creating a report document that includes one or more features of the analysis of the data.

20. The method of claim 19, wherein the method further includes:
generating an alert condition via one or more alert mechanisms to indicate a condition of the analyzed data.

21. The method of claim 20, wherein generating an alert condition includes generating the alert condition by causing one or more light emitting diodes to illuminate.

22. The method of claim 19, wherein the method further includes:
generating a template that serves as a standardized page format, followed by textual and graphical information that summarizes and graphs the sensor data.

23. The method of claim 22, wherein the method further includes:
formatting an initial document page including defining any geometric constructions and defining any verbiage to be used within the document.

24. The method of claim 23, wherein the method further includes:
retrieving verbiage from memory associated with the electronic circuitry based on the defined verbiage needed for formatting the initial document page.
